(19) United States
(12) Patent Application Publication
(10) Pub. No.: US 2020/0223272 A1
(43) Pub. Date: Jul. 16, 2020

(54) STRUCTURAL MEMBER AND MANUFACTURING METHOD OF THE STRUCTURAL MEMBER

(71) Applicant: Kabushiki Kaisha Kobe Seiko Sho (Kobe Steel, Ltd.), Kobe-shi (JP)

(72) Inventor: Hiroaki HOSOI, Kobe-shi (JP)

(73) Assignee: Kabushiki Kaisha Kobe Seiko Sho (Kobe Steel, Ltd.), Kobe-shi (JP)

(21) Appl. No.: 16/731,148

(22) Filed: Dec. 31, 2019

(30) Foreign Application Priority Data
Jan. 11, 2019 (JP) 2019-003174

(51) Int. Cl. B60G 7/00

(52) U.S. Cl. CPC B60G 7/001; B60G 2206/81022; B60G 2204/143

(57) ABSTRACT

Both weight reduction and inhibition of torsional rigidity deterioration in a structural member requiring a torsional rigidity against a torsional moment are attained.

A structural member has a first end including a first attaching part, a second end including a second attaching part, and an arm extending from the first end to the second end. The arm has a first outside surface, a second outside surface, and an arm surface. The arm has a first rib and a second rib protruding from the arm surface in a thickness direction. The first rib extends in an inclination direction that is a direction directed from the first outside surface toward the second outside surface and is a direction having a component of an arm direction. The second rib is formed so as to intersect with the first rib.

### BACKGROUND

The present invention relates to a structural member requiring a torsional rigidity against a torsional moment.

Weight reduction of a structural member constituting a product has heretofore been worked on for environmental protection and energy consumption control in industry. As one of such efforts, weight reduction of a structural member for an automobile is worked on in the automotive industry (for example, Japanese Unexamined Patent Application Publication No. 2003-211929).

### SUMMARY

Meanwhile, since an automobile includes many parts, the layout of each part is greatly restricted. As a result, a structural member for an automobile includes a curved part having a three-dimensionally complexly curved shape in many cases. When a load is applied to a structural member including such a curved part, not only a bending moment but also a torsional moment acts on the structural member and hence a stress caused by torsional deformation is generated in addition to a stress caused by bending deformation in the structural member. The structural member therefore requires a high torsional rigidity. When the weight of the structural member is reduced therefore, a torsional rigidity is required to be inhibited from deteriorating.

The above requirement also applies widely to another structural member, except a structural member for an automobile, including such a curved part and requiring weight reduction.

The present invention has been established in order to solve the above problem and an object of the present invention is to attain both weight reduction and inhibition of torsional rigidity deterioration in a structural member requiring a torsional rigidity against a torsional moment.

The present invention provides a structural member having a first end including a first attaching part attached to a first member that is different from the structural member, a second end including a second attaching part attached to a second member that is different from the structural member, and an arm extending from the first end to the second end and including a curved part having a curved shape. The arm has a first outside surface and a second outside surface that are located on both the sides of the arm in a width direction and formed along an arm direction that is a direction of extending the arm and an arm surface that is a surface located on one side of the arm in a thickness direction perpendicular to the width direction and formed along the arm direction. The arm has a first rib and a second rib that protrude from the arm surface in the thickness direction. The first rib extends in a first inclination direction that is a direction directed from the first outside surface toward the second outside surface and is a direction having a component of the arm direction. The second rib is formed so as to intersect with the first rib.

In a structural member according to the present invention, since the arm includes such a curved part as stated above, when the arm receives a load from the first member and the second member that are members different from the structural member through the first end and the second end, not only a bending moment but also a torsional moment acts on the arm and the torsional moment generates a torsional stress in the arm. In this way, a structural member according to the present invention requires a torsional rigidity against a torsional moment. In a structural member according to the present invention, the torsional rigidity of the arm is enhanced by the first rib and the second rib formed at the arm. A structural member according to the present invention therefore can use a low density material as a material constituting an arm and reduce the dimensions including a width and a thickness of the arm in comparison with a case of not forming the first rib and the second rib. A structural member according to the present invention therefore makes it possible to attain both weight reduction and inhibition of torsional rigidity deterioration.

In the structural member, it is preferable that: the arm direction is a direction directed from the first end toward the second end; and the second rib extends in a second inclination direction that is a direction directed from the second outside surface toward the first outside surface and is a direction having a component of the arm direction. In this embodiment, whereas the first rib extends in the direction directed from the first outside surface toward the second outside surface, the second rib extends in the direction directed from the second outside surface toward the first outside surface. That is, since the first rib and the second rib are arranged at positions relatively well balanced with the first outside surface and the second outside surface of the arm, the torsional rigidity of the arm is enhanced more effectively.

In the structural member, it is preferable that, when a line formed by connecting the center position of the arm in the width direction continuously from the first end toward the second end is defined as a center line when the arm is viewed in the thickness direction, the first rib and the second rib incline to the center line in directions opposite to each other and intersect with the center line when the arm is viewed in the thickness direction. In the embodiment, the first rib and the second rib are arranged so as to incline to the center line of the arm in directions opposite to each other and intersect with the center line, respectively. That is, the first rib and the second rib are arranged at positions relatively well balanced with the center line of the arm and hence the torsional rigidity of the arm is enhanced more effectively.

In the structural member, it is preferable that at least either of the first rib and the second rib is configured so that an inclination angle of the rib to the arm direction may fall within the range of 20° to 60°. In the embodiment, the torsional rigidity of the arm is enhanced more effectively.

It is preferable that: the structural member is a suspension member for an automobile interposed between a wheel and a vehicle body; either of the first attaching part and the second attaching part is a part that receives a load from the wheel; and the other of the first attaching part and the second attaching part is a part that receives a load from the vehicle body. Various members such as a wheel, a drive shaft, a shock absorber, and a coil spring are arranged around a suspension member and the members have movable ranges respectively. The suspension member therefore is required not to interfere with the other members and the layout of the suspension member is greatly restricted. As a result, the suspension member generally includes a curved part having a three-dimensionally complexly curved shape. When a load is applied to a suspension member including such a curved part, a stress caused by a torsional deformation is generated in addition to a stress caused by a bending deformation in the suspension member and hence the suspension member is required to have a high torsional rigidity. Further, weight reduction of a suspension member: contributes to the reduction of an unsprung weight of an automobile; contributes largely to the improvement of kinematical performance and driver's ride comfort and the like; and hence is highly prioritized in the efforts to reduce weight. By using the structural member as a suspension member for an automobile therefore, the suspension member can obtain both improvement of kinematical performance and ride comfort caused by weight reduction and inhibition of torsional rigidity deterioration.

It is preferable that the suspension member comprises an aluminum alloy. In recent years, a suspension member comprising an aluminum alloy tends to be increasingly adopted mostly in luxury cars as one of the efforts to reduce the weight of a structural member for an automobile. The use of an aluminum alloy as a suspension member can contribute to the weight reduction of an automobile. Although the strength of an aluminum alloy improves more than before, a Young's modulus of an aluminum alloy is smaller than a Young's modulus of a steel sheet or a cast iron for example. When the weight of a suspension member including such a curved part as stated above is reduced by an aluminum alloy therefore, torsional rigidity deterioration has to be inhibited. In the embodiment therefore, the suspension member can obtain both weight reduction and inhibition of torsional rigidity deterioration by an aluminum alloy.

In the structural member, it is preferable that: the arm has a recess that is recessed in the thickness direction; the recess has a base extending along the arm direction and a first sidewall and a second sidewall that protrude from both the ends of the base in the width direction respectively toward the one of the thickness directions; the base has an arm inner surface that is an inner surface located at the base in the one of the thickness directions and formed along the arm direction; the arm inner surface constitutes at least a part of the arm surface; and the first rib and the second rib are formed so as to protrude from the arm inner surface in the thickness direction. When a part or the whole of the arm includes the base, the first sidewall, and the second sidewall like this embodiment, in other words, when a part or the whole of the arm includes a structure having a nearly U-shaped cross section, a shear center can be brought close to a load point. A torsional moment acting on the structural member therefore can be reduced and hence the weight of the structural member can be reduced further. In the embodiment therefore, both the effect of reducing weight by forming the first rib and the second rib and the effect of reducing weight by forming a recess having a nearly U-shaped cross section can be obtained.

In the structural member, it is preferable that, when a region formed by surrounding an arbitrary cross section of the arm perpendicular to the arm direction with a shortest distance line is defined as a subsumption region, an end of the subsumption region in the thickness direction is defined as a region end A, a vector perpendicular to the cross section is defined as a vector n, a point where a load acts on the structural member is defined as a load point O, a distance between the region end A and the load point O in a direction parallel with the vector n is defined as a first distance L, and a distance between the region end A and the load point O in a direction perpendicular to the vector n is defined as a second distance δ, the first rib and the second rib are formed in the range of the arm satisfying a condition represented by an inequality L<4 δ. In the embodiment, the second distance δ correlates with a degree of curvature in the curved part of the arm. That is, the second distance δ increases if the curved part of the arm curves largely in an arch shape for example. Further, the load point O is a part corresponding to the first attaching part or the second attaching part in the structural member. The inequality therefore indicates that a range where the first rib and the second rib are formed, namely a distance from the first attaching part or the second attaching part in the direction of the vector n, may be increased as the second distance δ increases. Then a torsional rigidity of the structural member can be enhanced more effectively by forming the first rib and the second rib in the range of the inequality.

In the structural member, the rigidity improvement effect can be obtained even when the protrusion height and the width are small to some extent and, when the structural member is manufactured by forging for example, it is preferable that both the first rib and the second rib are configured respectively so that: a protrusion height from the arm surface in the thickness direction may be 5 mm or more; and a width in a direction perpendicular to the thickness direction may be 1 mm or more.

In the structural member, it is preferable that a 0.2% proof stress in tensile test is 340 MPa or more.

A manufacturing method of a structural member according to the present invention includes a process of forming the structural member described above by hot-forging an aluminum alloy material. In the hot forging, the degree of freedom in shape is high in comparison with a plate material and an extruded material, an arbitrary wall thickness and cross-sectional shape can be obtained, and hence free structural design is possible. A manufacturing method according to the present invention therefore makes it possible to form the first rib and the second rib with a high degree of accuracy in the structural member.

The present invention makes it possible to attain both weight reduction and inhibition of torsional rigidity deterioration in a structural member including a curved part having a curved shape.

### BRIEF DESCRIPTION OF THE DRAWINGS

FIG. 1 is a perspective view showing a suspension member according to a first embodiment of the present invention.

FIG. 2 is a perspective view showing the suspension member according to the first embodiment.

FIG. 3 is a view of the suspension member according to the first embodiment viewed in a thickness direction of an arm.

FIG. 4 is a sectional view taken on line IV-IV in FIG. 3.

FIG. 5 is a sectional view taken on line V-V in FIG. 3.

FIG. 6 is a view obtained by enlarging a part in FIG. 3.

FIG. 7 is a perspective view showing a suspension member according to a second embodiment of the present invention.

FIG. 8 is a perspective view showing the suspension member according to the second embodiment.

FIG. 9 is a view of the suspension member according to the second embodiment viewed in a thickness direction of an arm.

FIG. 10 is a sectional view taken on line X-X in FIG. 9.

FIG. 11 is a sectional view taken on line XI-XI in FIG. 9.

FIG. 12 is a perspective view showing a suspension member according to a third embodiment of the present invention.

FIG. 13 is a perspective view showing the suspension member according to the third embodiment.

FIG. 14 is a view of the suspension member according to the third embodiment viewed in a thickness direction of an arm.

FIG. 15 is a sectional view taken on line XV-XV in FIG. 14.

FIG. 16 is a sectional view taken on line XVI-XVI in FIG. 14.

FIG. 17 is a view showing a nearly H-shaped cross-sectional model used for analysis for verifying the effect of improving rigidity by forming a cross rib.

FIG. 18 is a view showing a nearly U-shaped cross-sectional model used for analysis for verifying the effect of improving rigidity by forming a cross rib.

FIG. 19 is a view showing a nearly U-shaped cross-sectional model that has a cross rib and is used for analysis for verifying the effect of improving rigidity by forming the cross rib.

FIG. 20 is a view for explaining analysis conditions for verifying the effect of improving rigidity by forming a cross rib.

FIG. 21 is a table showing analysis conditions and analysis results for verifying the effect of improving rigidity by forming a cross rib.

FIG. 22 is a view showing a topology optimization model.

FIG. 23 is a table showing analysis conditions and analysis results of a topology optimization method.

FIG. 24 is a graph showing a range preferable as a region where a cross rib is formed.

FIG. 25 is a graph for explaining a subsumption region and a subsumption area.

FIG. 26 is a view showing analysis conditions for verifying the influence of an angle of a rib on a rigidity improvement effect.

FIG. 27 is a graph showing a relationship between an angle of a cross rib and a rigidity per unit mass.

FIG. 28 is a graph showing a relationship between an angle of a cross rib and a rigidity per unit mass.

### DETAILED DESCRIPTION

Preferred embodiments according to the present invention are explained hereunder in reference to the drawings.

### First Embodiment

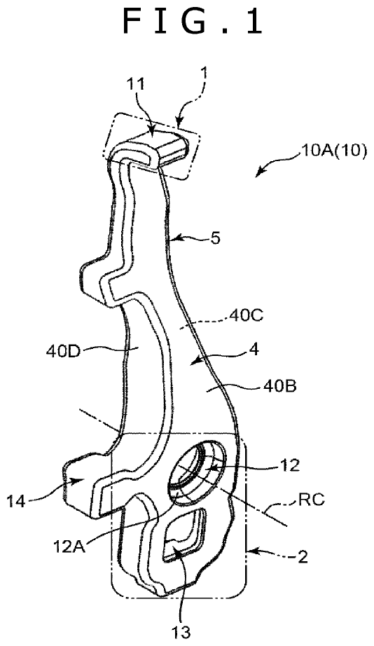

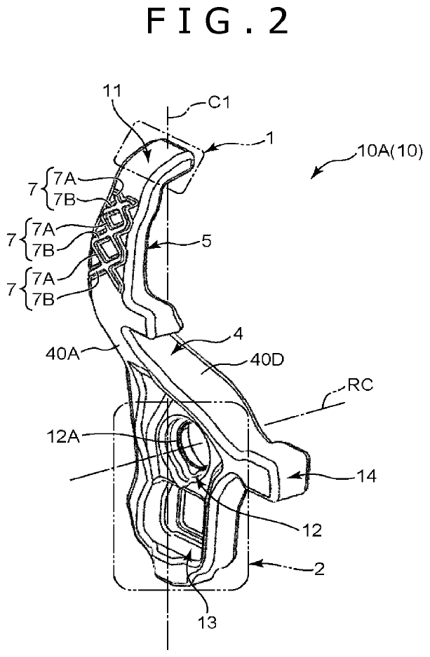

FIGS. 1 and 2 are perspective views showing a suspension member 10 according to a first embodiment of the present invention. The suspension member 10 according to the first embodiment is a high mount knuckle 10A and the high mount knuckle 10A constitutes a part of a suspension unit, not shown in the figures, for an automobile. FIGS. 1 and 2 show postures when the high mount knuckle 10A is incorporated into the suspension unit.

The suspension unit: is a unit mounted on a vehicle body of an automobile not shown in the figures; and supports a wheel (tire) of the automobile rotatably and steerably. As an example, in the present embodiment, a pair of suspension units are arranged in accordance with the left and right front wheels of an automobile respectively. Each of the suspension units: has a high mount knuckle 10A and a lower arm 10B (refer to FIG. 8) to be described later; and further has a tie rod, a shock absorber, a pair of upper arms, and the like, which are not shown in the figures. The high mount knuckle 10A: supports the wheel rotatably; and is connected to the lower arm 10B and the shock absorber.

As shown in FIGS. 1 and 2, the high mount knuckle 10A has a first end 1 (upper end), a second end 2 (lower end), and an arm 4. The arm 4 has a shape extending in an arch shape, the first end 1 is connected to an end (upper end) of the arm 4, and the second end 2 is connected to the other end (lower end) of the arm 4.

The first end 1 includes a first attaching part 11. The first attaching part 11 is a part attached to a member different from the high mount knuckle 10A. Specifically, the first attaching part 11 is connected to ends of the paired upper arms and pivotally supported by the paired upper arms. The other ends of the paired upper arms are connected respectively to the vehicle body. The first attaching part 11 therefore is a part that receives a load from the vehicle body.

The second end 2 includes a second attaching part 12 and a third attaching part 13. The second attaching part 12 and the third attaching part 13 are parts attached to members different from the high mount knuckle 10A. Specifically, the second attaching part 12 is a part attached to the wheel. The second attaching part 12 therefore is a part that receives a load from the wheel. The second attaching part 12 has a through-hole 12A penetrating in a vehicle width direction. The second attaching part 12 supports a bearing, not shown in the figures, constituting a rotating shaft of the wheel. A shaft (not shown in the figures) of the wheel is inserted into the through-hole 12A of the second attaching part 12. A dash-dot line RC shown in FIGS. 1 and 2 represents a position of a rotation center of the shaft of the wheel and represents a position of a center RC of the through-hole 12A.

The third attaching part 13 is a part attached to the shock absorber. The third attaching part 13 is formed at a part extending from the second attaching part 12 to a direction opposite to the first attaching part 11. The third attaching part 13 is connected to a lower end of the shock absorber and pivotally supported by the shock absorber. In this way, the high mount knuckle 10A is configured so as to be rotatable around a central axis C1 shown in FIG. 2 by being pivotally supported by the paired upper arms at the first attaching part 11 and being pivotally supported by the shock absorber at the third attaching part 13.

The high mount knuckle 10A further has a tie rod support 14 and the tie rod support 14 pivotally supports a tip of the tie rod. The tie rod extends from a steering gear box that is not shown in the figures. When the tie rod moves left and right as an automobile is driven, the high mount knuckle 10A rotates around the central axis C1 and the wheel is steered around the central axis C1.

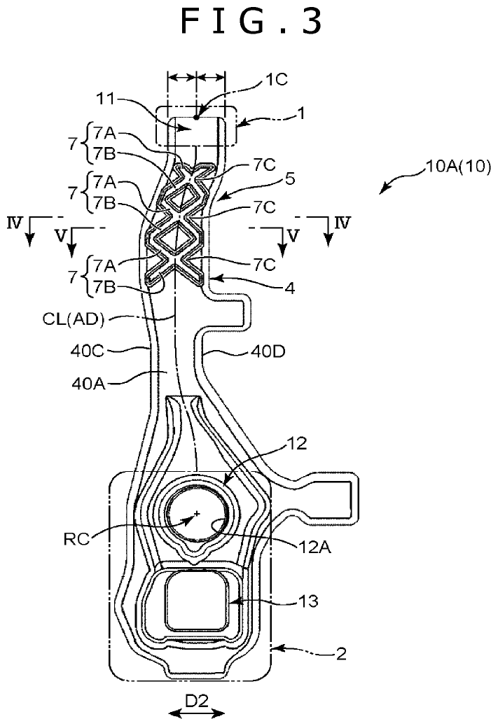

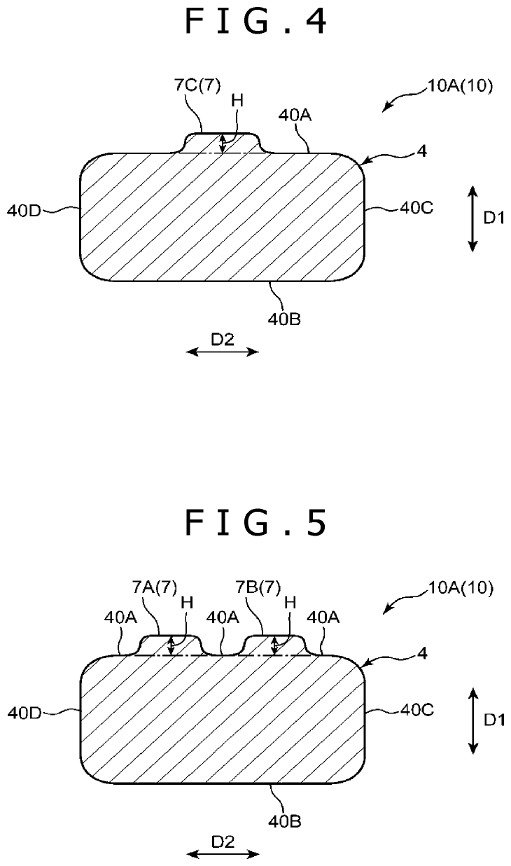

FIG. 3 is a view of the high mount knuckle 10A viewed in a thickness direction of the arm 4. FIG. 4 is a sectional view taken on line IV-IV in FIG. 3 and FIG. 5 is a sectional view taken on line V-V in FIG. 3.

In the present embodiment, a thickness direction D1 of the arm 4 is a direction identical to the direction of the center RC of the through-hole 12A in the second attaching part 12 (rotation center RC of the shaft). Further, in the present embodiment, a width direction D2 of the arm 4 is a direction perpendicular to the thickness direction D1. More specifically, it is as follows. When the arm 4 is viewed in the thickness direction D1 as shown in FIG. 3, the width direction D2 of the arm 4 is a direction that is perpendicular to a straight line connecting a center position 1C of the first end 1 and the center RC of the through-hole 12A and also perpendicular to the thickness direction D1.

Further, in the present embodiment, an arm direction AD shown in FIG. 3 is a direction extending the arm 4 and is a direction directed from the first end 1 toward the second end 2. The arm direction AD can be represented by a center line CL that is a line continuously connecting the center position of the arm 4 in the width direction D2 from the first end 1 toward the second end 2 when the arm 4 is viewed in the thickness direction D1 as shown in FIG. 3.

The arm 4 has a shape extending from the first end 1 to the second end 2. The arm 4 includes a curved part 5 having a shape that curves in order to avoid interference with members such as the wheel. As shown in FIG. 2, the curved part 5 is a part arranged at a position laterally away from the central axis C1 of the high mount knuckle 10A.

In the present embodiment, since the arm 4 includes such a curved part 5 as stated above, when the arm 4 receives a load through the first end 1 and the second end 2, not only a bending moment but also a torsional moment acts on the arm 4 and the torsional moment generates a torsional stress in the arm 4. In this way, the high mount knuckle 10A according to the present embodiment requires a torsional rigidity against the torsional moment. When a degree of curvature in the curved part 5 increases, the high mount knuckle 10A sometimes has a part where a deformation caused by a torsional moment is larger than a deformation caused by a bending moment.

The arm 4 has a surface 40A (arm surface 40A) and a rear surface 40B, which are located on both the sides of the arm 4 in the thickness direction D1 and formed along the arm direction AD. Further, the arm 4 has a first outside surface 40C and a second outside surface 40D, which are located on both the sides of the arm 4 in the width direction D2 and formed along the arm direction AD.

As shown in FIGS. 2, 3, and 5, the arm 4 has a first rib 7A and a second rib 7B, which protrude from the arm surface 40A in one of the thickness directions D1 (upper direction in FIG. 5). The first rib 7A and the second rib 7B constitute a cross rib 7 by intersecting with each other. The first rib 7A and the second rib 7B intersect at an intersection 7C. In the first embodiment, the arm 4 has a plurality of cross ribs 7 (specifically, three cross ribs 7). The cross ribs 7 are aligned along the arm direction AD. Although adjacent cross ribs 7 are placed next to each other in the present embodiment, the cross ribs 7 are not limited to this case and may also be arranged at intervals in the arm direction AD.

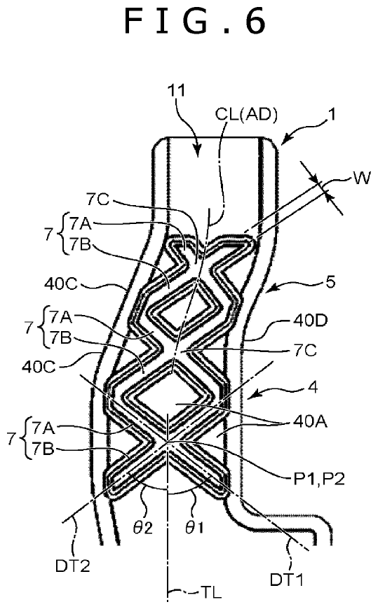

As shown in FIG. 6, each of the first ribs 7A is formed so as to extend in a first inclination direction DT1 that is a direction directed from the first outside surface 40C toward the second outside surface 40D and is a direction having a component of the arm direction AD. Each of the second ribs 7B is formed so as to intersect with a relevant first rib 7A. Each of the second ribs 7B is formed so as to extend in a second inclination direction DT2 that is a direction directed from the second outside surface 40D toward the first outside surface 40C and is a direction having a component of the arm direction AD. The first ribs 7A and the second ribs 7B are formed so as to intersect with each other and incline to the arm direction AD (center line CL) in directions opposite to each other when the arm 4 is viewed in the thickness direction D1 as shown in FIGS. 3 and 6.

Inclination angles θ1 and θ2 of the respective first ribs 7A and second ribs 7B with respect to the arm direction AD (center line CL) may fall desirably within the range of 20° to 60° and more desirably within the range of 30° to 45°.

A dash-dot line TL shown in FIG. 6 is a tangent TL of the center line CL at an intersection point P1 between the first rib 7A and the center line CL when the arm 4 is viewed in the thickness direction D1. The inclination angle θ1 of the first rib 7A to the arm direction AD is an angle formed between the tangent TL of the center line CL and the first inclination direction DT1 when the arm 4 is viewed in the thickness direction D1. In the specific example shown in FIG. 6 further, an intersection point P2 between the second rib 7B and the center line CL is located at a position nearly identical to the intersection point P1 and the dash-dot line TL also represents a tangent TL of the center line CL at the intersection point P2 between the second rib 7B and the center line CL. The inclination angle θ2 of the second rib 7B to the arm direction AD is an angle formed between the tangent TL of the center line CL and the second inclination direction DT2 when the arm 4 is viewed in the thickness direction D1. Here, the intersection point P1 and the intersection point P2 may also be located at positions different from each other.

A protrusion height H of the respective first rib 7A and second rib 7B is desirably 5 mm or more and more desirably 8 mm or more. Further, a width W of the respective first rib 7A and second rib 7B is desirably 1 mm or more and more desirably 4 mm or more.

The protrusion height H of a rib is a distance in the thickness direction D1 from the arm surface 40A to the tip of the rib (the first rib 7A or the second rib 7B) in the thickness direction D1 in a cross section obtained by cutting the arm 4 on a plane parallel with the thickness direction D1 (for example, such a cross section as shown in FIG. 5). The width W of a rib is a size of the rib in a direction perpendicular to a direction extending the rib when the arm 4 is viewed in the thickness direction D1 as shown in FIG. 6.

### Second Embodiment

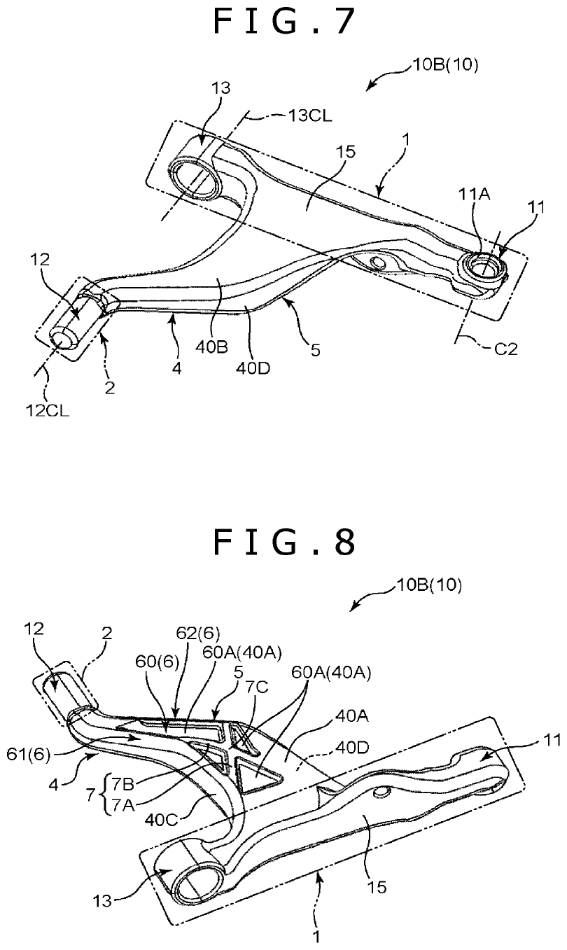

FIGS. 7 and 8 are perspective views showing a suspension member 10 according to a second embodiment of the present invention. The suspension member 10 according to the second embodiment is a lower arm 10B (front lower arm) and the lower arm 10B constitutes a part of the suspension unit stated earlier.

As shown in FIGS. 7 and 8, the lower arm 10B has a first end 1, a second end 2, and an arm 4. The arm 4 has a shape extending in an arch shape, the first end 1 is connected to an end of the arm 4, and the second end 2 is connected to the other end of the arm 4.

The first end 1 includes a first attaching part 11 and a third attaching part 13. Specifically, the first end 1 includes the first attaching part 11, the third attaching part 13, and a connection 15 to connect those attaching parts. The connection 15 is a part of the first end 1 extending in a width direction D2 to be described later. The arm 4 is connected to a middle part of the connection 15 between the first attaching part 11 and the third attaching part 13.

The second end 2 includes a second attaching part 12. The first attaching part 11, the second attaching part 12, and the third attaching part 13 are parts attached to members different from the lower arm 10B. Specifically, the first attaching part 11 is connected to both or either of a lower part of the shock absorber and a lower part of the high mount knuckle 10A, those being described earlier, and the second attaching part 12 and the third attaching part 13 are supported by another part of the suspension unit or the vehicle body, those being described earlier. The first attaching part 11 is a part that receives a load from the wheel described earlier and the second attaching part 12 and the third attaching part 13 are parts that receive a load from the vehicle body.

The first attaching part 11 has a hole 11A (through hole) that penetrates in a direction of a center axis C2 or a hole 11A (recess) that is recessed in a direction of the center axis C2. The direction of the center axis C2 of the hole 11A of the first attaching part 11: is identical to the direction of the center axis C1 of the high mount knuckle 10A shown in FIG. 2 in the present embodiment; but is not limited to the direction; and may also be a direction different from the center axis C1.

The second attaching part 12 has a columnar shape (for example, a round columnar shape) extending along a center axis 12CL. Further, the third attaching part 13 has a tubular shape (for example, a round tubular shape) extending along a center axis 13CL. The center axis 12CL of the second attaching part 12 and the center axis 13CL of the third attaching part 13: are on an identical line in the present embodiment; but are not limited to this case; and may also be deviated from each other. Here, the second attaching part 12 may also have a tubular shape similarly to the third attaching part 13 and the third attaching part 13 may also have a columnar shape similarly to the second attaching part 12.

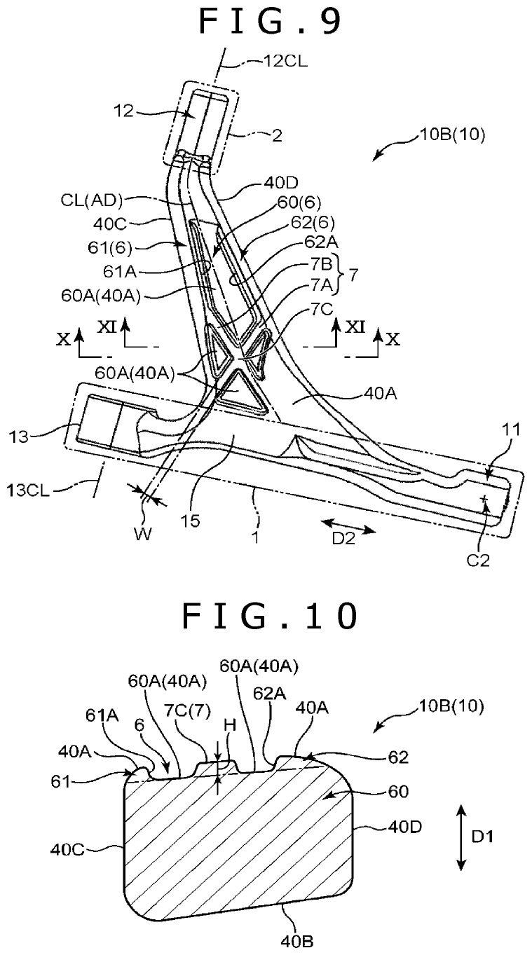

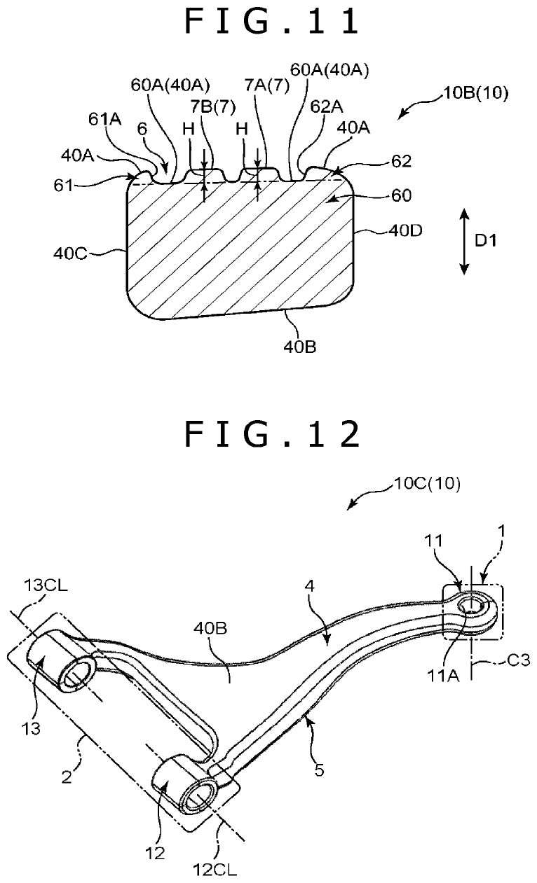

FIG. 9 is a view of a suspension member 10 according to the second embodiment viewed in the thickness direction D1 of the arm 4. FIG. 10 is a sectional view taken on line X-X in FIG. 9 and FIG. 11 is a sectional view taken on line XI-XI in FIG. 9.

In the present embodiment, the thickness direction D1 of the arm 4 is a direction identical to the center axis C2 of the hole 11A of the first attaching part 11. Further, in the present embodiment, the width direction D2 of the arm 4 is a direction perpendicular to the thickness direction D1. More specifically, it is as follows. When the arm 4 is viewed in the thickness direction D1 as shown in FIG. 9, the width direction D2 of the arm 4 is a direction that is perpendicular to the center axis 12CL of the second attaching part 12 (or the center axis 13CL of the third attaching part 13) and also perpendicular to the thickness direction D1.

Furthermore, in the present embodiment, an arm direction AD shown in FIG. 9 is a direction extending the arm 4 and is a direction directed from the first end 1 toward the second end 2. The arm direction AD can be represented by a center line CL that is a line continuously connecting the center position of the arm 4 in the width direction D2 from the first end 1 toward the second end 2 when the arm 4 is viewed in the width direction D1 as shown in FIG. 9.

The arm 4 has a shape extending from the first end 1 to the second end 2. The arm 4 includes a curved part 5 having a shape that curves in order to avoid interference with another member. The arm 4 has a surface 40A (arm surface 40A) and a rear surface 40B, which are located on both the sides of the arm 4 in the thickness direction D1 and formed along the arm direction AD. Further, the arm 4 has a first outside surface 40C and a second outside surface 40D, which are located on both the sides of the arm 4 in the width direction D2 and formed along the arm direction AD.

In the second embodiment, the arm 4 has a recess 6 that is recessed in the thickness direction D1 (on the side of the rear surface 40B in the thickness direction D1). The recess 6 has a base 60 extending along the arm direction AD and a first sidewall 61 and a second sidewall 62 that protrude in one of the thickness directions D1 (upward in FIG. 11) from both the ends of the base 60 in the width direction D2 respectively.

The base 60 has an arm inner surface 60A that is an inner surface located on one side of the base 60 in the thickness direction D1 and formed along the arm direction AD. The arm inner surface 60A constitutes at least a part of the arm surface 40A.

As shown in FIGS. 8, 9, and 11, the arm 4 has a first rib 7A and a second rib 7B that protrude in one of the thickness directions D1 (upward in FIG. 11) from the arm inner surface 60A of the arm surface 40A. The first rib 7A and the second rib 7B constitute a cross rib 7 by intersecting with each other. The first rib 7A and the second rib 7B intersect at an intersection 7C. The arm 4: has only one cross rib 7 in the second embodiment; but is not limited to this case; and may also have a plurality of cross ribs 7 like the first embodiment.

As shown in FIG. 9, the first rib 7A is formed so as to extend in a first inclination direction that is a direction directed from the first outside surface 40C toward the second outside surface 40D and is a direction having a component of the arm direction AD. The second rib 7B is formed so as to intersect with the first rib 7A.

The second embodiment is different from the first embodiment on the point that the second rib 7B is formed so as to extend in a second inclination direction that is a direction directed from the connection 15 of the first end 1 toward the first outside surface 40C and is a direction having a component of the arm direction AD as shown in FIG. 9.

The first rib 7A and the second rib 7B are formed so as to intersect with each other and incline to the arm direction AD (center line CL) in directions opposite to each other respectively when the arm 4 is viewed in the thickness direction D1 as shown in FIG. 9.

Preferable ranges of inclination angles θ1 and θ2, a protrusion height H, and a width W of the first rib 7A and second rib 7B are identical to the first embodiment.

### Third Embodiment

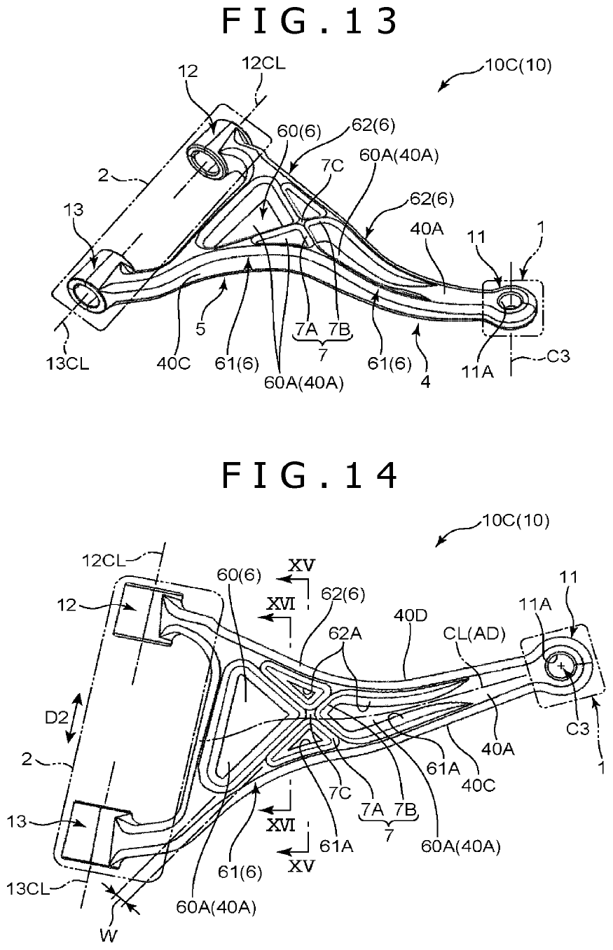

FIGS. 12 and 13 are perspective views showing a suspension member 10 according to a third embodiment of the present invention. The suspension member 10 according to the third embodiment is a rear upper arm 10C and the rear upper arm 10C constitutes a part of each of a pair of suspension units arranged in accordance with left and right rear wheels. The rear upper arm 10C supports a rear wheel through a knuckle not shown in the figures together with a rear lower arm not shown in the figures.

As shown in FIGS. 12 and 13, the rear upper arm 10C has a first end 1, a second end 2, and an arm 4. The arm 4 has a shape extending in an arch shape, the first end 1 is connected to an end of the arm 4, and the second end 2 is connected to the other end of the arm 4.

The first end 1 includes a first attaching part 11. The second end 2 includes a second attaching part 12 and a third attaching part 13. The first attaching part 11, the second attaching part 12, and the third attaching part 13 are parts attached to members different from the rear upper arm 10C. Specifically, the first attaching part 11 is a part attached to a rear wheel through the knuckle described earlier. The second attaching part 12 and the third attaching part 13 are supported by another part of the suspension unit or a vehicle body, those being described earlier. The first attaching part 11 is a part that receives a load from the wheel described earlier and the second attaching part 12 and the third attaching part 13 are parts that receive a load from the vehicle body described earlier.

The first attaching part 11 has a hole 11A (through hole) that penetrates in a direction of a center axis C3 or a hole 11A (recess) that is recessed in a direction of the center axis C3. The direction of the center axis C3 of the hole 11A of the first attaching part 11: is a vertical direction for example in the present embodiment; but is not limited to the direction; and may also be another direction.

The second attaching part 12 has a tubular shape (for example, a round tubular shape) extending along a center axis 12CL. Further, the third attaching part 13 has a tubular shape (for example, a round tubular shape) extending along a center axis 13CL. The center axis 12CL of the second attaching part 12 and the center axis 13CL of the third attaching part 13: are on an identical line in the present embodiment; but are not limited to this case; and may also be deviated from each other.

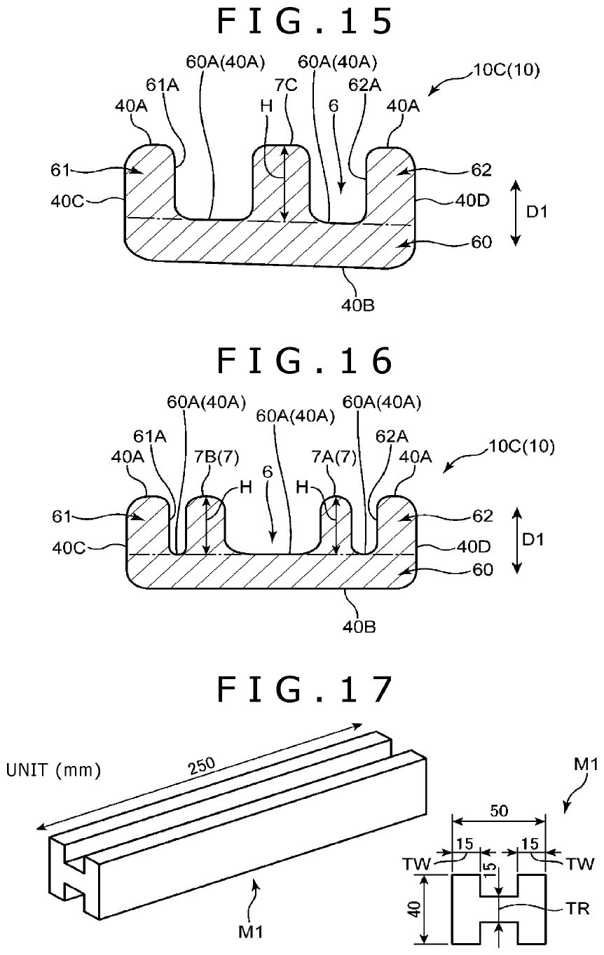

FIG. 14 is a view of the rear upper arm 10C according to the third embodiment viewed in the thickness direction D1 of the arm 4. FIG. 15 is a sectional view taken on line XV-XV in FIG. 14 and FIG. 16 is a sectional view taken on line XVI-XVI in FIG. 14.

In the present embodiment, the thickness direction D1 of the arm 4 is a direction identical to the center axis C3 of the hole 11A of the first attaching part 11. Further, in the present embodiment, a width direction D2 of the arm 4 is a direction perpendicular to the thickness direction D1. More specifically, it is as follows. When the arm 4 is viewed in the thickness direction D1 as shown in FIG. 14, the width direction D2 of the arm 4 is a direction that is parallel with the center axis 12CL of the second attaching part 12 (or the center axis 13CL of the third attaching part 13).

Furthermore, in the present embodiment, an arm direction AD shown in FIG. 14 is a direction extending the arm 4 and is a direction directed from the first end 1 toward the second end 2. The arm direction AD can be represented by a center line CL that is a line continuously connecting the center position of the arm 4 in the width direction D2 from the first end 1 toward the second end 2 when the arm 4 is viewed in the thickness direction D1 as shown in FIG. 14.

The arm 4 has a shape extending from the first end 1 to the second end 2. The arm 4 includes a curved part 5 having a shape that curves in order to avoid interference with another member. The arm 4 has a surface 40A (arm surface 40A) and a rear surface 40B, which are located on both the sides of the arm 4 in the thickness direction D1 and formed along the arm direction AD. Further, the arm 4 has a first outside surface 40C and a second outside surface 40D, which are located on both the sides of the arm 4 in the width direction D2 and formed along the arm direction AD.

In the third embodiment, the arm 4 has a recess 6 that is recessed in the thickness direction D1 (on the side of the rear surface 40B in the thickness direction D1). The recess 6 has a base 60 extending along the arm direction AD and a first sidewall 61 and a second sidewall 62 that protrude in one of the thickness directions D1 (upward in FIG. 16) from both the ends of the base 60 in the width direction D2 respectively.

The base 60 has an arm inner surface 60A that is an inner surface located on one side of the base 60 in the thickness direction D1 and formed along the arm direction AD. The arm inner surface 60A constitutes at least a part of the arm surface 40A.

As shown in FIGS. 13, 14, and 16, the arm 4 has a first rib 7A and a second rib 7B that protrude in one of the thickness directions D1 (upward in FIG. 16) from the arm inner surface 60A of the arm surface 40A. The first rib 7A and the second rib 7B constitute a cross rib 7 by intersecting with each other. The first rib 7A and the second rib 7B intersect at an intersection 7C. The arm 4: has only one cross rib 7 in the third embodiment; but is not limited to this case; and may also have a plurality of cross ribs 7 like the first embodiment.

As shown in FIG. 14, the first rib 7A is formed so as to extend in a first inclination direction that is a direction directed from the first outside surface 40C toward the second outside surface 40D and is a direction having a component of the arm direction AD. The second rib 7B is formed so as to intersect with the first rib 7A. The second rib 7B is formed so as to extend in a second inclination direction that is a direction directed from the second outside surface 40D toward the first outside surface 40C and is a direction having a component of the arm direction AD.

The first rib 7A and the second rib 7B are formed so as to intersect with each other and incline to the arm direction AD (center line CL) in directions opposite to each other respectively when the arm 4 is viewed in the thickness direction D1 as shown in FIG. 14.

Preferable ranges of inclination angles θ1 and θ2, a protrusion height H, and a width W of the first rib 7A and second rib 7B are identical to the first embodiment.

### Manufacturing Method

In the first to third embodiments, the high mount knuckle 10A, the lower arm 10B, and the rear upper arm 10C are members comprising aluminum alloys. In the first to third embodiments, such a suspension member 10 is formed integrally by hot-forging an aluminum alloy material. A 0.2% proof stress of the suspension member 10 is set so as to be 340 MPa or more in tensile test using a test piece taken from an arbitrary part of the suspension member 10. The 0.2% proof stress may also be an average value of multiple test results. As the test piece, a JIS No. 4 test piece can be used for example.

In the present embodiment, a final shape is obtained after two to four hot forging processes. On this occasion, in comparison with a plate material and an extruded material, the degree of freedom in shape is high, an arbitrary wall thickness and cross-sectional shape can be obtained, and hence a free structural design is possible.

An aluminum alloy has a density of about one third of an iron or steel material but also has a relatively high strength. By changing the material of a suspension member 10 from a steel sheet or a cast iron to an aluminum alloy therefore, generally a weight reduction of about 40% to 60% can be obtained. Among aluminum alloys, an alloy or a tempered alloy having a higher 0.2% proof stress generally can yield a higher weight reduction effect. As such aluminum alloys, 2000 series, 6000 series, and 7000 series alloys, which are heat-treated type alloys, are suitable from the viewpoint of material strength but the 2000 series and 7000 series alloys are inferior in corrosion resistance to a 6000 series alloy. As a suspension member 10 therefore, a 6000 series alloy, in particular, a 6082 alloy, a 6061 alloy, or an improved alloy having a composition similar to those, which balances strength and corrosion resistance, is adopted in many cases. In the case of such a 6000 series alloy, generally aging treatment is applied by T6 treatment or T7 treatment.

By the suspension member 10 according to the embodiment explained above, since the torsional rigidity of the arm 4 is enhanced by the first rib 7A and the second rib 7B formed in the arm 4, the torsional rigidity is inhibited from deteriorating while the weight of the suspension member 10 is reduced in comparison with a case of not forming such ribs. Specifically, it is as follows.

The magnitude of a torsional moment is proportional to a distance between a shear center and a load point in a cross section when the load point is projected on a plane identical to the cross section of a structural member. Since each of the high mount knuckle 10A, the lower arm 10B, and the rear upper arm 10C according to the first to third embodiments stated above has such a curved part 5 as stated above, a distance between a shear center and a load point increases and a torsional moment increases. Although it is effective to design a shear center so as to be brought close to a load point in order to inhibit a torsional moment, in a suspension member 10 for an automobile, it is necessary to avoid interference with surrounding other parts, a layout is constrained, and hence it is difficult to design that way. By making a cross section of a suspension member 10 a nearly U-shaped cross section, a shear center comes close to a load point. Since a range where a shear center can move by adopting a structure of a nearly U-shaped cross section however is small, when a load point is located at a position deviated largely from a cross section lower end like a suspension for an automobile, the effect of inhibiting a torsional moment by adopting a nearly U-shaped cross-sectional structure is small.

A principal stress caused by torsion comprises, in the case of a round bar, a tensile stress and a compressive stress of ±45° directions with respect to a longitudinal direction. This is also true for an arbitrary cross-sectional shape. The inventors of the present invention, focusing on this point, have tried to improve torsional rigidity in a structural member by forming a cross rib extending along the directions of the principal stress in the structural member.

Specifically, the present inventors have conducted 1) verification of rigidity improvement effect by forming a cross rib (a first rib and a second rib) in a structural member, 2) verification of conditions allowing a large effect to be obtained by forming the cross rib, and 3) verification of influence of an angle of a rib on the rigidity improvement effect.

1) Verification of rigidity improvement effect by forming a cross rib in a structural member

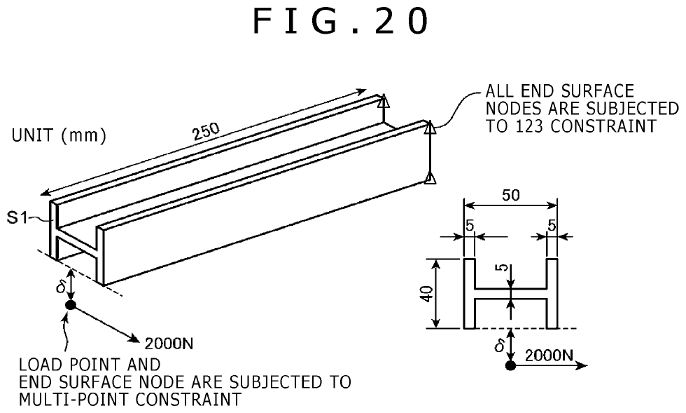

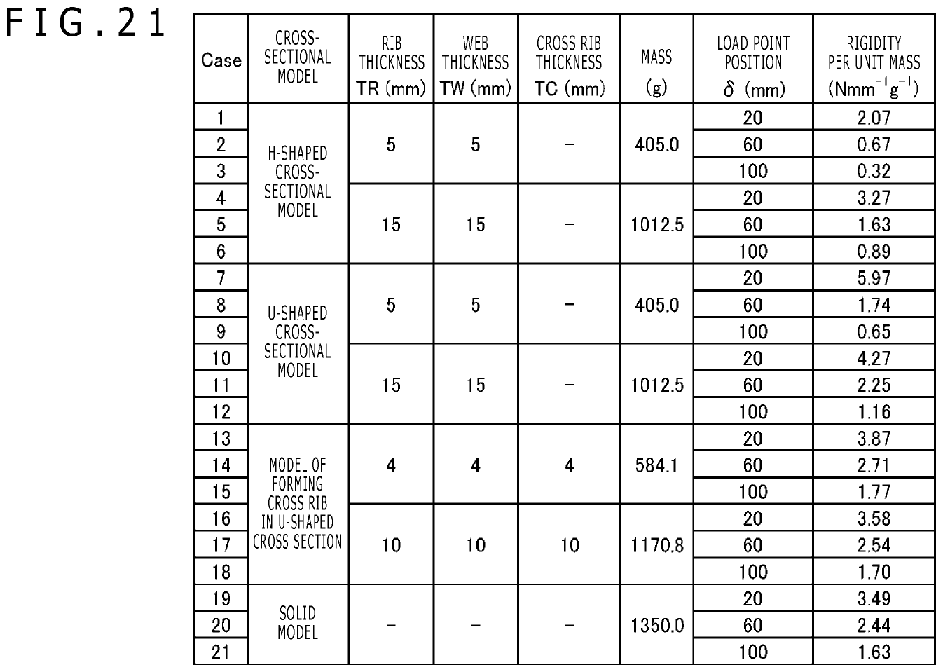

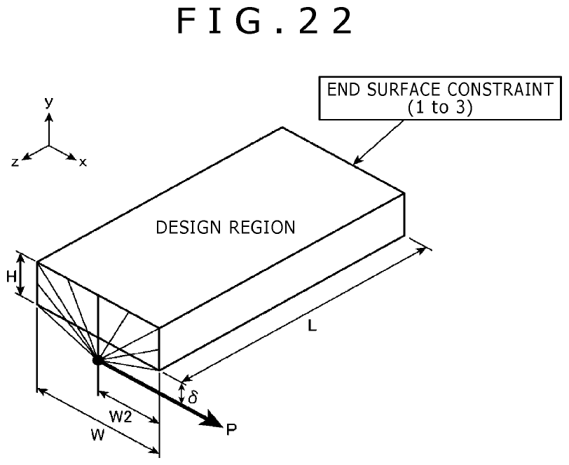

As the structural members of the analysis objects, a structural member M1 having a nearly H-shaped cross section, a structural member M2 having a nearly U-shaped cross section, a structural member M3 forming a cross rib in a structural member having a nearly U-shaped cross section, and a solid structural member M4 are used. FIGS. 17, 18, and 19 are views showing the structural members M1, M2, and M3. FIG. 20 is a view for explaining analysis conditions and FIG. 21 is a table showing the analysis conditions and the analysis results.

In each of the structural members M1, M2, M3, and M4, the longitudinal dimension is set at 250 mm, the height is set at 40 mm, and the width is set at 50 mm. As shown in FIG. 21, thin-wall models and thick-wall models are used for the analyses in the structural members M1, M2, and M3.

The rib thickness TR and the web thickness TW are set at 5 mm in the thin-wall model of the structural member M1 (nearly H-shaped cross-sectional model) and the rib thickness TR and the web thickness TW are set at 15 mm in the thick-wall model of the structural member M1. Here, FIG. 17 shows the thick-wall model of the structural member M1.

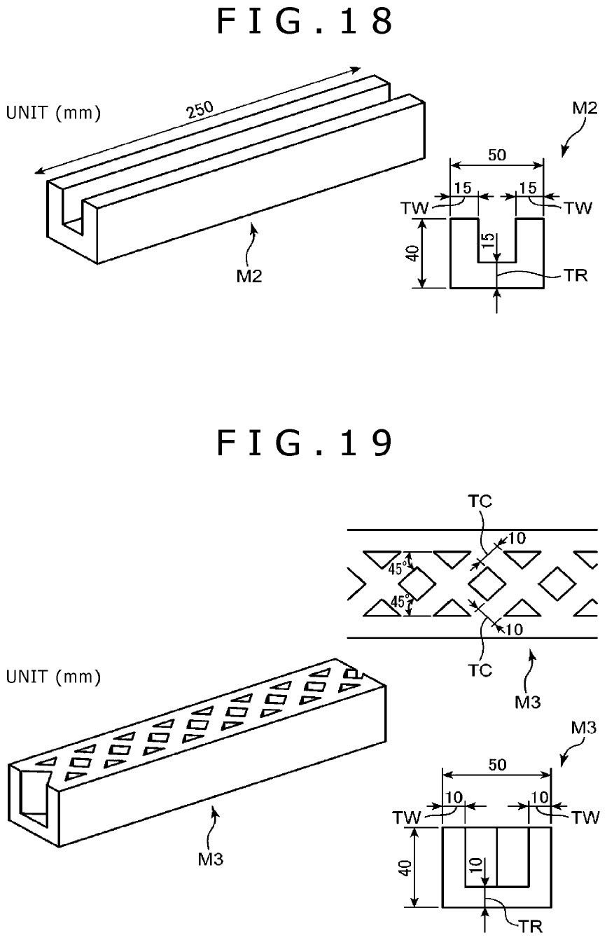

The rib thickness TR and the web thickness TW are set at 5 mm in the thin-wall model of the structural member M2 (nearly U-shaped cross-sectional model) and the rib thickness TR and the web thickness TW are set at 15 mm in the thick-wall model of the structural member M2. Here, FIG. 18 shows the thick-wall model of the structural member M2.

The rib thickness TR and the web thickness TW are set at 4 mm in the thin-wall model of the structural member M3 (model of forming a cross rib in a structural member having a nearly U-shaped cross-section) and the rib thickness TR and the web thickness TW are set at 10 mm in the thick-wall model of the structural member M3. Further, the cross rib thickness TC is set at 4 mm in the thin-wall model of the structural member M3 and the cross rib thickness TC is set at 10 mm in the thick-wall model of the structural member M3. The cross rib thickness TC is the dimension of the part corresponding to the width W of the rib shown in FIG. 6. The inclination angle of the cross rib is set at 45° in the structural member M3. The inclination angle is an angle corresponding to the inclination angle θ1 of the first rib 7A and the inclination angle θ2 of the second rib 7B shown in FIG. 6. Here, FIG. 19 shows the thick-wall model of the structural member M3.

As shown in FIG. 20, in the analysis, a model in which each of the structural members is supported in the state of a cantilever, a point offset by a distance δ downward from a position corresponding to the lower end of an end surface S1 of a structural member is set at a load point, and a bending load of 2,000 N is applied to the load point is adopted. In the model, the load point and an end surface node are subjected to multi-point constraint (MPC) and all the end surface nodes in an end surface on a fixed side are subjected to translation constraint (123 constraint).

As shown in the table of FIG. 21, the analysis is carried out on three conditions of setting the offset distance δ of a load point at 20 mm, 60 mm and 100 mm. As the material characteristics of the structural members, the Young's modulus is set at 68,600 MPa and the Poisson's ratio is set at 0.3. ABAQUS that is general-purpose FEM software is used for the analysis and rigidity is obtained from displacement of a load point in the loading direction. Rigidity per unit mass is used for comparison in the table of FIG. 21 since the models have different masses.

As shown in the table of FIG. 21, rigidity per unit mass lowers markedly as the offset distance δ increases. This is presumably because the influence of a torsional moment increases as the offset distance δ increases.

Further, as shown in the table of FIG. 21, under the condition of setting the offset distance δ at 20 mm, the rigidity per unit mass of the structural member M2 (nearly U-shaped cross-sectional model) is the largest and rigidity improvement effect by the cross rib in the structural member M3 (model of forming a cross rib in a structural member having a nearly U-shaped cross-section) is not recognized. In contrast, as the offset distance δ increases and the influence of a torsional moment increases, the rigidity improvement effect by the cross rib is obviously recognized. In other words, under the condition of setting the offset distance δ at 60 mm or 100 mm, the rigidity per unit mass of the structural member M3 (model of forming a cross rib in a structural member having a nearly U-shaped cross-section) is the largest. Under the condition of setting the offset distance δ at 100 mm in particular, the rigidity improvement effect by the cross rib is recognized markedly and the rigidity per unit mass is 1.5 times or more than the rigidity per unit mass of the structural member M2 (nearly U-shaped cross-sectional model).

Further, the rigidity per unit mass of the structural member M3 (model of forming a cross rib in a structural member having a nearly U-shaped cross-section) is slightly larger than the rigidity per unit mass of the structural member M4 (solid model) and the structural member M3 is excellent in rigidity by mass ratio.

2) Verification of conditions allowing a large effect to be obtained by forming the cross rib

Conditions allowing a large effect to be obtained by forming the cross rib are hereunder verified by applying a topology optimization method. As the analysis software used for topology optimization, structure optimization software OptiStruct made by Altair Engineering, Ltd. is used.

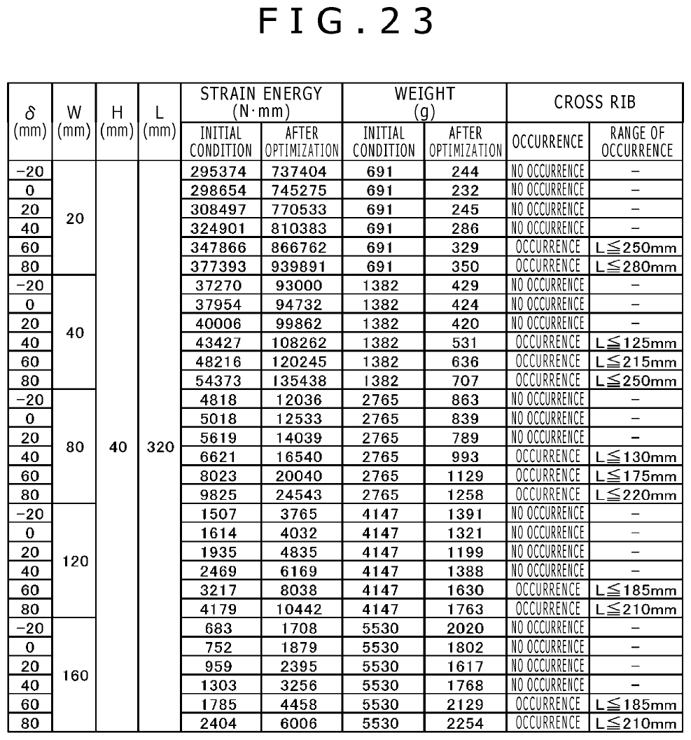

FIG. 22 is a view showing a topology optimization model and FIG. 23 is a table showing analysis conditions and analysis results of a topology optimization method. In the topology optimization model shown in FIG. 22, the longitudinal dimension L is set at 320 mm and the height H is set at 40 mm. Further, in the topology optimization model, rigidity optimization calculation of 30 conditions in total is carried out by varying the width W (cross-sectional width W) as shown in the table of FIG. 23 and varying the offset distance δ as shown in the table of FIG. 23. As restrictive conditions, the minimum wall thickness is set at 10 mm and the strain energy is set at 2.5 times or less than an initial model ratio. Further, constraint of limiting a demolding direction to the Y axis direction is also added in order to come close to a shape that can be manufactured by forging.

Further, in the analysis, the conditions of supporting a topology optimization model in the state of a cantilever, setting a point offset by a distance δ downward from a position corresponding to the lower end (region end A) of an end surface of the model at a load point, and adding a load P to the load point O are adopted. In the model, the load point O and an end surface node are subjected to multi-point constraint (MPC) and all the end surface nodes in an end surface on a fixed side are subjected to translation constraint (123 constraint).

As shown in the table of FIG. 23, in a region where an offset distance δ is large and also a bending moment is small, a cross rib intersecting in the manner of inclining in directions opposite to each other with respect to a longitudinal direction at angles of about 45° to the longitudinal direction is generated at a web position. Further, in the model, when a distance from a load point in a longitudinal direction increases, a bending moment tends to dominate and a cross rib tends to disappear.

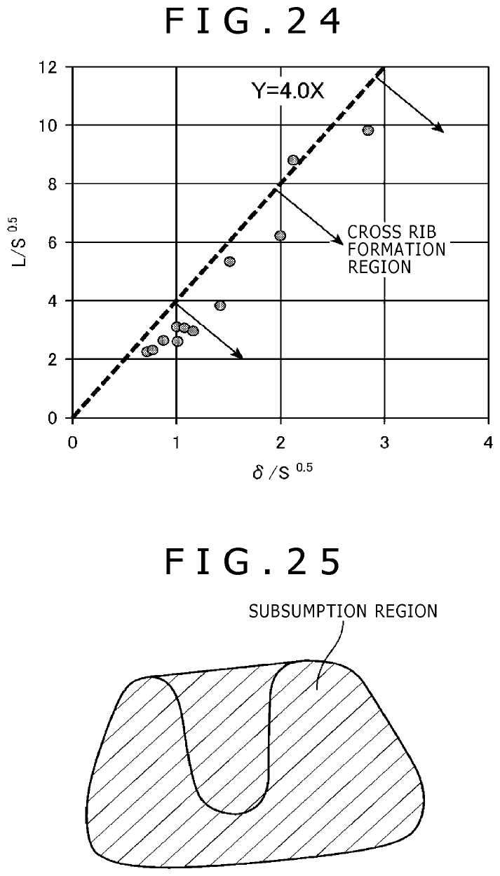

FIG. 24 is a graph summarizing the analysis results shown in FIG. 23. The graph of FIG. 24 illustrates a region where a cross rib is effective in the above model. The graph shows a relationship between an offset distance δ and a distance L from an end surface of the above model in a longitudinal direction. When the graph of FIG. 24 is created on the basis of the analysis results of FIG. 23, a subsumption region is defined with respect to an arbitrary cross section of the model shown in FIG. 25 and the values on the vertical axis and the horizontal axis of the graph shown in FIG. 24 are nondimensionalized by using a subsumption area S that is the area of the subsumption region. Specifically, in the graph of FIG. 24, the vertical axis is represented by “L/S^{0.5}” by using the subsumption area S and the horizontal axis is represented by “δ/S^{0.5}” by using the subsumption area S. Here, a subsumption region is a region formed by surrounding a cross section with a shortest distance line and a subsumption area S is an area of the subsumption region.

As shown in FIG. 24, it is verified that to form a cross rib in the region represented by the inequality “L/S^{0.5}≤4.0 δ/S^{0.5}”, that is, in the region represented by the inequality “L≤4.0 δ”, is effective for improving rigidity. Here, the distance L is a distance from an end surface of a model to a cross section where a cross rib is formed in a direction of a normal vector n perpendicular to the cross section.

3) Verification of influence of an angle of a rib on rigidity improvement effect

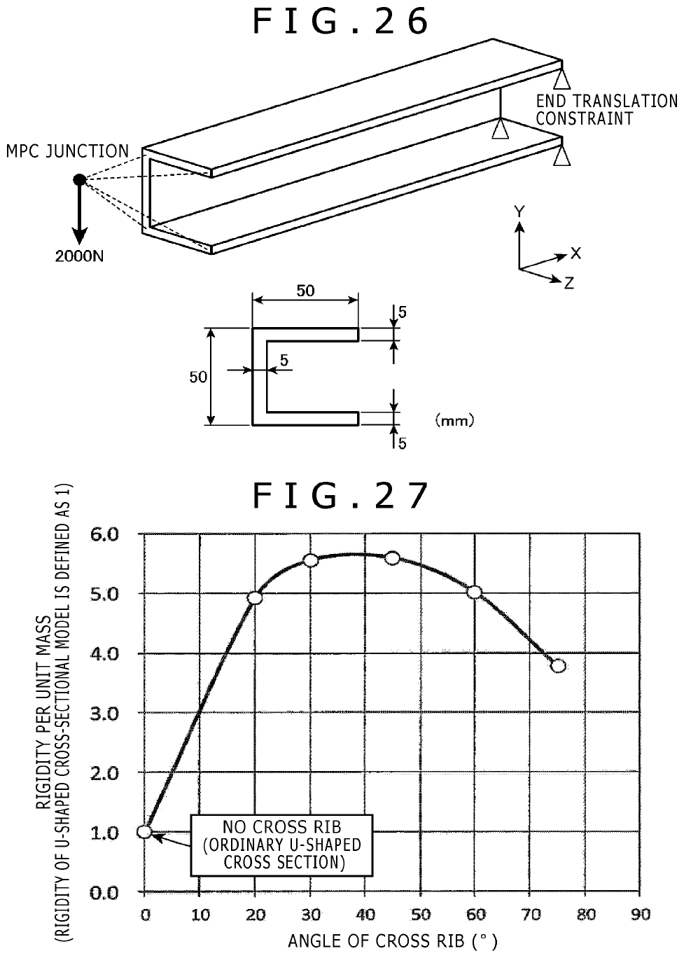

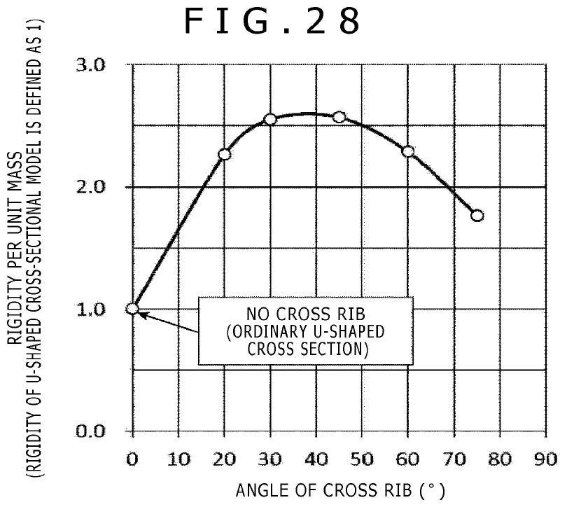

Relationship between an angle of a rib and a rigidity per unit mass is analyzed hereunder. FIG. 26 shows a model used for the analysis. FIGS. 27 and 28 are graphs showing analysis results.

As shown in FIG. 26, in the analysis, a model of adding a bending load of 2,000 N to a load point is adopted, the load point and an end surface node are subjected to multi-point constraint (MPC), and an end surface node in an end surface on a fixed side is subjected to translation constraint. Here, the dimensions of the model shown in FIG. 26 are the dimensions of the model of the analysis object used for the analysis relating to FIG. 28. Details on the dimensions of the model will be described later.

A model shown in FIG. 26 represents a structural member (U-shaped cross-sectional model) not forming a cross rib and having a nearly U-shaped cross section. The results of analyzing rigidity per unit mass of the U-shaped cross-sectional model are plotted at a position of zero on the horizontal axis (an angle of a cross rib) in the graphs shown in FIGS. 27 and 28. That is, in FIGS. 27 and 28, a rigidity per unit mass of the U-shaped cross-sectional model is used as the standard (a rigidity per unit mass of the U-shaped cross-sectional model is defined as “1”).

In the graphs shown in FIGS. 27 and 28, the results of analyzing rigidity per unit mass of a plurality of structural members (a plurality of cross rib models) having cross ribs are also plotted. The multiple cross rib models have cross rib angles (inclination angles) of 20°, 30°, 45°, 60°, and 75°, respectively. The cross rib models are models formed by further adding cross ribs having the above predetermined angles to the U-shaped cross-sectional model shown in FIG. 26. Rigidities per unit mass of the cross rib models are plotted in the graphs shown in FIGS. 27 and 28 as values based on the rigidity per unit mass of the U-shaped cross-sectional model, in other words as ratios to the rigidity per unit mass of the U-shaped cross-sectional model that is regarded as “1”, respectively.

The dimensions of the structural members used as the analysis objects are different as follows between the conditions of the analysis in which the results shown in the graph of FIG. 27 are obtained and the conditions of the analysis in which the results shown in the graph of FIG. 28 are obtained.

That is, in the analysis of FIG. 27, a structural member having a nearly U-shaped cross section of 40 mm in height, 50 mm in width, 4 mm in wall thickness, and 250 mm in length is used as the U-shaped cross-sectional model of the analysis object. Further, in the analysis of FIG. 27, a plurality of structural members formed by adding cross ribs 4 mm in wall thickness to the U-shaped cross-sectional model having the above dimensions are used as the multiple cross rib models of the analysis objects, respectively. In the multiple cross rib models, the angle between a cross rib and a longitudinal direction of a structural member is changed variously as described earlier.

On the other hand, in the analysis of FIG. 28, a structural member having a nearly U-shaped cross section of 50 mm in height, 50 mm in width, 5 mm in wall thickness, and 250 mm in length is used as the U-shaped cross-sectional model of the analysis object. Further, in the analysis of FIG. 28, a plurality of structural members formed by adding cross ribs 5 mm in wall thickness to the U-shaped cross-sectional model having the above dimensions are used as the multiple cross rib models of the analysis objects, respectively. In the multiple cross rib models, the angle between a cross rib and a longitudinal direction of a structural member is changed variously as described earlier.

As shown in FIGS. 27 and 28, it is verified that a high rigidity improvement effect is obtained when an inclination angle of a rib to a longitudinal direction of a structural member falls within the range of 20° to 60° and it is verified that an especially high rigidity improvement effect is obtained when an inclination angle of a rib to a longitudinal direction of a structural member falls within the range of 30° to 45°.

### Modified Examples

The present invention is not limited to the embodiments explained above. The present invention includes the following embodiments for example.

A) Although the case where an arm 4 of a suspension member 10 has a surface 40A (arm surface 40A) and a rear surface 40B and a first rib 7A and a second rib 7B are formed on the surface 40A is exemplified in the above embodiments, the present invention is not limited to this case. The surface 40A and the rear surface 40B in the arm 4 are relative to each other and, although the terms “surface 40A” and “rear surface 40B” are used for convenience in the embodiments, the terms may be used reversely. The first rib 7A and the second rib 7B therefore may be formed at a part corresponding to the rear surface 40B. Further, the first rib 7A and the second rib 7B may be formed on both the surface 40A and the rear surface 40B.

B) Although the case of manufacturing a suspension member 10 by hot forging is exemplified in the above embodiments, a structural member according to the present invention may be manufactured by casting for example.

C) A structural member according to the present invention: is not limited to a suspension member 10 according the above embodiments; may be a structural member for an automobile other than the suspension member 10; and may be another structural member that is different from a structural member for an automobile, includes a curved part as stated above, and requires weight reduction.

This application claims the benefits of priority to Japanese Patent Application No. 2019-003174, filed Jan. 11, 2019. The entire contents of the above application are herein incorporated by reference.

What is claimed is:

1. A structural member comprising:
a first end including a first attaching part attached to a first member that is different from the structural member;
a second end including a second attaching part attached to a second member that is different from the structural member; and
an arm extending from the first end to the second end and including a curved part having a curved shape, wherein:
the arm has a first outside surface and a second outside surface that are located on both the sides of the arm in a width direction and formed along an arm direction that is a direction of extending the arm and an arm surface that is a surface located on one side of the arm in a thickness direction perpendicular to the width direction and formed along the arm direction;
the arm has a first rib and a second rib that protrude from the arm surface in the thickness direction;
the first rib extends in a first inclination direction that is a direction directed from the first outside surface toward the second outside surface and is a direction having a component of the arm direction; and
the second rib is formed so as to intersect with the first rib.

2. A structural member according to claim 1, wherein:
the arm direction is a direction directed from the first end toward the second end; and
the second rib extends in a second inclination direction that is a direction directed from the second outside surface toward the first outside surface and is a direction having a component of the arm direction.

3. A structural member according to claim 1, wherein, when a line formed by connecting the center position of the arm in the width direction continuously from the first end toward the second end is defined as a center line when the arm is viewed in the thickness direction, the first rib and the second rib incline to the center line in directions opposite to each other and intersect with the center line when the arm is viewed in the thickness direction.

4. A structural member according to claim 1, wherein at least either of the first rib and the second rib is configured so that an inclination angle of the rib to the arm direction may fall within the range of 20° to 60°.

5. A structural member according to claim 1, wherein:
the structural member is a suspension member for an automobile interposed between a wheel and a vehicle body;
either of the first attaching part and the second attaching part is a part that receives a load from the wheel; and
the other of the first attaching part and the second attaching part is a part that receives a load from the vehicle body.

6. A structural member according to claim 5, wherein the suspension member comprises an aluminum alloy.

7. A structural member according to claim 1, wherein:
the arm has a recess that is recessed in the thickness direction;
the recess has a base extending along the arm direction and a first sidewall and a second sidewall that protrude from both the ends of the base in the width direction respectively toward the one of the thickness directions;
the base has an arm inner surface that is an inner surface located at the base in the one of the thickness directions and formed along the arm direction;
the arm inner surface constitutes at least a part of the arm surface; and
the first rib and the second rib are formed so as to protrude from the arm inner surface in the thickness direction.

8. A structural member according to claim 1, wherein, when
a region formed by surrounding an arbitrary cross section of the arm perpendicular to the arm direction with a shortest distance line is defined as a subsumption region,
an end of the subsumption region in the thickness direction is defined as a region end A,
a vector perpendicular to the cross section is defined as a vector n,
a point where a load acts on the structural member is defined as a load point O,
a distance between the region end A and the load point O in a direction parallel with the vector n is defined as a first distance L, and
a distance between the region end A and the load point O in a direction perpendicular to the vector n is defined as a second distance δ,
the first rib and the second rib are formed in the range of the arm satisfying a condition represented by an inequality L≤4
δ.

9. A structural member according to claim 1, wherein both the first rib and the second rib are configured respectively so that:
a protrusion height from the arm surface in the thickness direction may be 5 mm or more; and
a width in a direction perpendicular to the thickness direction may be 1 mm or more.

10. A structural member according to claim 1, wherein a 0.2% proof stress in tensile test is 340 MPa or more.

11. A manufacturing method of a structural member including a process of forming a structural member according to claim 1 by hot-forging an aluminum alloy material.
